(19) United States
(12) Patent Application Publication
(10) Pub. No.: US 2009/0306235 A1
(43) Pub. Date: Dec. 10, 2009

(54) Memory Foam Pad

(76) Inventor: Wang Jin Quan, Wujiang (CN)

Correspondence Address: FROST BROWN TODD, LLC, 2200 PNC CENTER, 201 E. FIFTH STREET, CINCINNATI, OH, 45202, US

(21) Appl. No.: 12/133,451

(22) Filed: Jun. 5, 2008

(51) Int. Cl. C08L 75/08; C08G 18/24

(52) U.S. Cl. 521/123; 521/149

(57) ABSTRACT

A memory foam pad that is porous enough to allow water to pass through it, and methods for making the memory foam pad.

### BACKGROUND

Memory foam is a polyurethane that is viscoelastic. Generally, it is firmer when cool and softer when warm. When it is warmed by body heat, the foam close to the body is softer and the foam further from the body provides firmer support. Because of this property it is often used as a mattress, pillows, or pads that are both soft and provide firm support.

The use of memory foam outside has been limited because it can trap water which can lead to mold and mildew growth, and a breakdown of the foam.

Consequently, a significant need exists for a memory foam that can allow water to drain from the foam while still maintaining soft and firm support and be stable to outdoor use.

### BRIEF SUMMARY

The above-noted and other deficiencies may be overcome by providing a memory foam pad comprising polyurethane, where the polyurethane is porous enough for efficient water drainage, and the density is greater than about 40 g/m³.

A process for making a memory foam pad comprises the steps of blending at least two polyethers, a tin catalyst, and a diisocyanate using a mixer rotating at about 150 rpm to form a polyurethane, and opening the cells of the polyurethane by placing the polyurethane under vacuum and heating it

These and other objects and advantages shall be made apparent from the accompanying drawings and the description thereof.

### DETAILED DESCRIPTION

A memory foam pad comprises polyurethane, where the polyurethane is porous enough for efficient water drainage, and the density is greater than about 40 g/m³. The memory foam pad may be used in a cushion. The cushion, or memory foam pad itself may be used on or in a chair or other furniture.

The polyurethane is porous enough for efficient water drainage; it may allow about 250 mL of water to pass through it in less than approximately 30 to 45 seconds, the water may pass through it in about 15 to about 25 seconds. In one embodiment the foam will retain only about 10 g of water when about 250 mL of water passes through a thickness of about 5 cm of polyurethane.

In one embodiment, the polyurethane may be formed from a mixture comprising two or more polyethers. The first polyether may be a low molecular weight polyoxypropylene triol. The triol may have a hydroxyl number ranging from about 250 to about 350, or from about 290 to about 320. The triol may have a density of about 1.03 g/ml at 25° C.

The second polyether may be a medium molecular weight polyoxypropylene or polyoxyethylene polyether triol. The molecular weight may be about 3000. The triol may have a hydroxyl number ranging from about 50 to about 60, or from about 54 to about 58.

In one embodiment, the mass ratio of first polyether to second polyether may range from about 4:1 to about 3:1, or about 3.7:1.

The mixture of polyethers may be blended with the polymerization catalyst prior to polymerization. Blending should be sufficient that the monomers and the catalyst are well mixed. The mixing time may be about one to about two minutes. The speed of the mixer may be about 300 rpm. Catalysts for forming polyurethanes are well known, such as a tin catalyst. An example of a tin catalyst is stannous octoate. A stabilizing agent may be blended with the mixture, such as a polysiloxane. The polysiloxane may be a copolymer of polysiloxane and poly(ethylene oxide).

The mixture used to form the polyurethane may additionally comprise a base. The base may be an amine. Examples of amine bases are triethylenediamine and triethylamine. The use of bases and amines in the polymerization of polyurethanes is well known and a suitable base could be selected by one of ordinary skill in the art. Examples of isocyanates for forming polyurethanes are well know, such as toluene diisocyanate and methylene diphenyl diisocyanate. The isocyanate may be dissolved in a mixture of di-propylenic glycol or mono-ethylenic glycol.

In one embodiment the reaction mixture used to form the polyurethane may additionally comprise a cell opener. Examples of a cell opener are polyether polyols. The ratio of cell opener to tin catalysts effects the porosity of the polyurethane. A higher ratio results in more porosity, while a lower ratio results in a polyurethane with less porosity. An example of a cell opener to tin catalyst ratio is about 1000:1.

In one embodiment, the process for making the polyurethane comprises the steps of blending at least two polyethers with a tin catalyst, diisocyanate, and polyethers to form the polyurethane. The blending may be done with a mixer. The speed of the mixer may be about 150 rpm. The mixing rates and the components determine the porosity and viscoelastic properties of the polyurethane. If the mixing speed is faster the porosity will be less, and if it is slower the porosity will be greater.

After the polyurethane is formed it may then be dried. After drying the cells of the polyurethane are opened by placing the polyurethane under vacuum and heating it to open the cells. The polyurethane may be heated by a mixture of acetylene and oxygen. By opening the cells the porosity is created. In one embodiment, the density of the polyurethane after the cells are opened is greater than about 40 g/m³.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art.

### EXAMPLES

### Example 1

A first polyether (22 kg, Yukol 1900) and a second polyether (6 kg, Yukol 5613) were blended for 1-2 minutes at a mixing speed of 300 rpm. Polysiloxane (550 g, tegostab B 8002) and a tin catalyst (15 g, stannous octoate) were added to the mixture and blended for 1 minute at a mixing speed of 300 rpm. Water (980 g), triethylenediamine (15 g, TEDA-A33), toluene diisocyanate (17 kg), and a cell opener (1.5 kg, Yukol 1900) were blended for about 10 seconds at a mixing speed of 150 rpm to form a polyurethane. The polyurethane was molded into the desired shape on a conveyer belt. The cells of the polyurethane were opened by placing the polyurethane under vacuum and heating it with a mixture of acetylene and oxygen.

What is claimed is:

1. A memory foam pad comprising polyurethane, where the polyurethane is porous enough for efficient water drainage, and the density is greater than about 40 g/m³.

2. A cushion comprising the memory foam pad of claim 1.

3. A chair comprising the cushion of claim 2.

4. The memory foam pad of claim 1, where the polyurethane is produced from a mixture comprising at least two polyether monomers, where the first polyether monomer is polyoxypropylene triol, and where the second polyether monomer is polyoxypropylene polyether triol or polyoxyethylene polyether triol.

5. The memory foam pad of claim 4, where the mixture further comprises toluene diisocyanate.

6. The memory foam pad of claim 4, where the mixture further comprises a cell opener.

7. The memory foam pad of claim 6, where the cell opener comprises a polyether polyol.

8. The memory foam pad of claim 4, where the first polyether monomer comprises a polyoxypropylene triol with a hydroxyl number ranging from about 250 to about 350.

9. The memory foam pad of claim 4, where the second polyether monomer comprises polyoxypropylene polyether triol or polyoxyethylene polyether triol, with a hydroxyl number ranging from about 50 to about 60.

10. The memory foam pad of claim 4, where the mixture further comprises stannous octoate.

11. The memory foam pad of claim 10, where the ratio of cell opener to stannous octoate is about 1000:1.

12. The memory foam pad of claim 4, where the mixture prior to polymerizing is blended using a mixer rotating at about 150 rpm.

13. The memory foam pad of claim 4, where the cell of the polyurethane are opened by placing the polyurethane under vacuum and heating it.

14. A process for making a memory foam pad comprising the steps of:
blending a mixture of at least two polyethers, a tin catalyst, and a diisocyanate using a mixer rotating at about 150 rpm to form a polyurethane, and
opening the cells of the polyurethane by placing the polyurethane under vacuum and heating it.

15. The process of claim 14, where at least one of the polyethers comprises a polyoxypropylene triol with a hydroxyl number ranging from about 250 to about 350; and where at least one of the polyethers comprises polyoxypropylene polyether triol or polyoxyethylene polyether triol, with a hydroxyl number ranging from about 50 to about 60.

16. The process of claim 14, where the diisocyanate comprises toluene diisocyanate.

17. The process of claim 14, where the mixture additional comprises a cell opener.

18. The memory foam pad of claim 17, where the ratio of cell opener to tin catalyst is about 1000:1.
